(19) United States
(12) Patent Application Publication
(10) Pub. No.: US 2008/0162862 A1
(43) Pub. Date: Jul. 3, 2008

(54) Signal Processing Apparatus and Signal Processing Method

(76) Inventors: Yoshiki Matsumoto, Osaka (JP); Takeshi Fujita, Osaka (JP); Yoshiaki Sawada, Osaka (JP); Yukari Sugino, Hyogo (JP)

Correspondence Address: MCDERMOTT WILL & EMERY LLP, 600 13TH STREET, NW, WASHINGTON, DC, 20005-3096, US

(21) Appl. No.: 11/883,802

(22) PCT Filed: Jul. 21, 2006
(86) PCT No.: PCT/JP2006/314512

§ 371 Date: Aug. 7, 2007

(30) Foreign Application Priority Data
Dec. 2, 2005 (JP) 2005-349875

(51) Int. Cl. G06F 12/06

(52) U.S. Cl. 711/171; 711/E12.084

(57) ABSTRACT

A signal processing apparatus includes a processing selection section (102), a processing execution section (103), a buffer (107) and a buffer size setting section (108A). The processing selection section (102) selects, from a plurality of signal processings, processing to be performed to input data. The processing execution section (103) executes signal processing selected by the processing selection section (102). The buffer (107) has a variable buffer size and buffers data processed by the processing execution section (103). The buffer size setting section (108A) sets the buffer size of the buffer (107) based on a selection result of the processing selection section (102).

### TECHNICAL FIELD

The present invention relates to a signal processing apparatus and a signal processing method, and more particularly relates to a signal processing technique for performing processing to input data and outputting processed data in real time.

### BACKGROUND ART

In a signal processing apparatus or a signal processing software program, when there is a difference in data transfer amount per processing and transfer rate between two separate processings, a buffer is provided between the two separate processings to perform smooth data transfer. Specifically, input data is stored in the buffer and at a time when an amount of stored data reaches a certain level, data in the buffer is output.

For example, an audio reproduction apparatus for converting data into PCM data by an audio decoder, performing additional processing and then outputting data from a buffer in real time will be described.

FIG. 7 is a diagram showing ideal change in a data amount in a buffer. In FIG. 7, arrows show time points of data input. Specifically, each of time points is timing of data input in units of a block or decoding, when block decoding or frame decoding and additional processing are completed. A buffer size is equivalent to a data amount per input. Output data is output so that a predetermined amount of data is output at a time according to a sampling frequency. In an ideal state, a sum of a decoding/adding time and a data transfer time is equivalent to a time when the amount of data stored in the buffer is zero and, moreover, an interval of data input into the buffer is not fluctuated at all, so that overflow or underflow does not occur.

However, in an actual situation, the sum of the decoding/adding time and the data transfer time is not necessarily equivalent to a time when the amount of data stored in the buffer is zero and an interval of data input into the buffer is fluctuated. Therefore, when all data in the buffer is gone, underflow occurs and output processing has to be stopped until the buffer is filled to some level. On the other hand, when data remain in the buffer and no capacity for next input data is left, overflow occurs and input processing has to be stopped.

Specifically, in an audio reproduction apparatus and the like which has to output data in real time, the occurrence of underflow causes notable reduction in reproduced sound quality such as a sound skip.

FIG. 8 is a diagram showing actual change in a data amount in a buffer. As shown in FIG. 8, when a buffer size is set to be equivalent to a single input data amount, overflow or underflow occurs due to the generation of temporal fluctuation of data input intervals.

Conventionally, a technique for reducing overflow by reducing an amount of data generated by signal processing mean when a room in which data is written in a buffer becomes small has been proposed (see, for example, Patent Reference 1).

### Patent Reference 1: Japanese Laid-Open Publication No. 10-210475

### DISCLOSURE OF THE INVENTION

### PROBLEMS THAT THE INVENTION IS TO SOLVE

As a method for solving the problems of underflow and overflow, a buffer size can be set to be sufficiently large. FIG. 9 is a diagram showing change in a data amount for a large volume buffer. In FIG. 9, considering temporal fluctuation, the buffer size is set to be twice as large as input data amount and thus overflow and underflow do not occur.

In general, however, fluctuation of an interval of data input into a buffer due to processing, i.e., fluctuation of a processing amount varies as the case may be. Thus, if a buffer size corresponding to processing in which a large fluctuation occurs is ensured at all the time, a resource is wasted in processing in which a small fluctuation occurs.

If the above-described known technique is used, a buffer size can be reduced. However, as compensation for the size reduction, some processing has to be skipped and operation precision has to be lowered, so that sound quality is reduced.

In view of the above-described problems, the present invention has been devised to realize a signal processing apparatus and a signal processing method which are capable of suppressing the occurrence of underflow using a buffer having a necessity minimum size without reduction of processing accuracy.

### SOLUTION TO THE PROBLEMS

As a signal processing apparatus, means which has been devised to solve the above-described problems according to the present invention includes a processing selection section for selecting, from a plurality of signal processings, processing to be executed to input data, a processing execution section for executing a signal processing selected by the processing selection section to the input data, a buffer for buffering data processed by the processing execution section, the buffer having a variable buffer size, and a buffer size setting section for setting a buffer size of the buffer based on a selection result of the processing execution section.

According to this means, based on the selection result of the processing selection section, the buffer size of the buffer having a variable buffer size can be set. Thus, the buffer size can be properly set according to selected processing, so that the occurrence of underflow can be prevented particularly without reducing processing precision. Moreover, the buffer size can be suppressed at a necessity minimum and an empty region of the buffer can be effectively utilized for some other processing.

Specifically, the buffer size setting section sets the buffer size corresponding to a type of processing selected by the processing selection section with reference to a predetermined table.

More specifically, the buffer size setting section adds a value corresponding to the type of the processing selected by the processing selection section to a specified value to calculate the buffer size.

Furthermore, more specifically, the buffer size setting section multiplies a specified value by a value corresponding to the type selected by the processing selection section.

Specifically, the buffer size setting section operates a variant indicating the selection result of the processing selection section using a predetermined function to calculate the buffer size.

Means devised according to the present invention includes, in a signal processing apparatus, a processing selection section for selecting, from a plurality of signal processings, processing to be executed to input data, a processing execution section for executing signal processing selected by the processing selection section to the input data, a buffer for buffering data processed by the processing execution section, the buffer having a variable buffer size, and a buffer size setting section for setting a buffer size of the buffer based on an external setting.

According to this means, the buffer size can be arbitrarily set, so that the buffer size can be suppressed at a necessity minimum.

Specifically, the buffer is formed of a memory.

Moreover, specifically, the buffer is formed of a disk drive.

Furthermore, as a signal processing method, means devised according to the present invention includes a first step of selecting, from a plurality of signal processings, processing to be executed to input data, a second step of executing signal processing selected in the first step to the input data, a third step of setting a buffer size of a buffer based on a selection result in the first step, the buffer having a variable buffer size, and a step of buffering the data processed in the second step to the buffer.

According to this means, the buffer size can be properly set according to selected processing, so that the occurrence of underflow can be prevented without reducing processing precision. Moreover, the buffer size can be suppressed at a necessity minimum and an empty region of the buffer can effectively utilized for some other processing.

Moreover, as a signal processing method, means devised according to the present invention includes a first step of selecting, from a plurality of signal processings, processing to be executed to input data, a second step of executing signal processing selected in the first step to the input data, a third step of setting a buffer size of a buffer based on a selection result in the first step, the buffer having a variable buffer size, and a step of buffering the data processed in the second step to the buffer.

According to this means, the buffer size can be arbitrarily set, so that the buffer size can be suppressed at a necessity minimum.

### EFFECTS OF THE INVENTION

As has been described, according to the present invention, in a signal processing apparatus and a signal processing method for processing input data and outputting processed data in real time, the occurrence of underflow can be prevented without reducing processing precision. Moreover, the buffer size can be suppressed at a necessity minimum and an empty region of a storage medium such as a memory or a disk drive in which a buffer is ensured can be effectively utilized for some other processing.

### BRIEF DESCRIPTION OF THE DRAWINGS

FIG. 1 is a diagram illustrating a configuration of a signal processing apparatus according to a first embodiment of the present invention.

FIG. 2 is a diagram illustrating an exemplary configuration of a processing execution section of FIG. 1.

FIG. 3 is an exemplary buffer size table.

FIG. 4 is another exemplary buffer size table.

FIG. 5 is still another exemplary buffer size table.

FIG. 6 is a diagram illustrating a configuration of a signal processing apparatus according to a second embodiment of the present invention.

FIG. 7 is a diagram showing ideal change in a data amount for a buffer.

FIG. 8 is a diagram showing actual change in a data amount for a buffer.

FIG. 9 is a diagram showing change in a data amount for a large volume buffer.

### EXPLANATION OF REFERENCE NUMERALS

101A, 101B Signal processing apparatus

102 Processing selection section

103 Processing execution section

107 Buffer

108A, 108B Buffer size setting section

### BEST MODE FOR CARRYING OUT THE INVENTION

Hereafter, embodiments of the present invention will be described in detail with reference to the accompanying drawings. The following preferred embodiments are merely examples, and there is no intention to limit the present invention and its application or use.

### First Embodiment

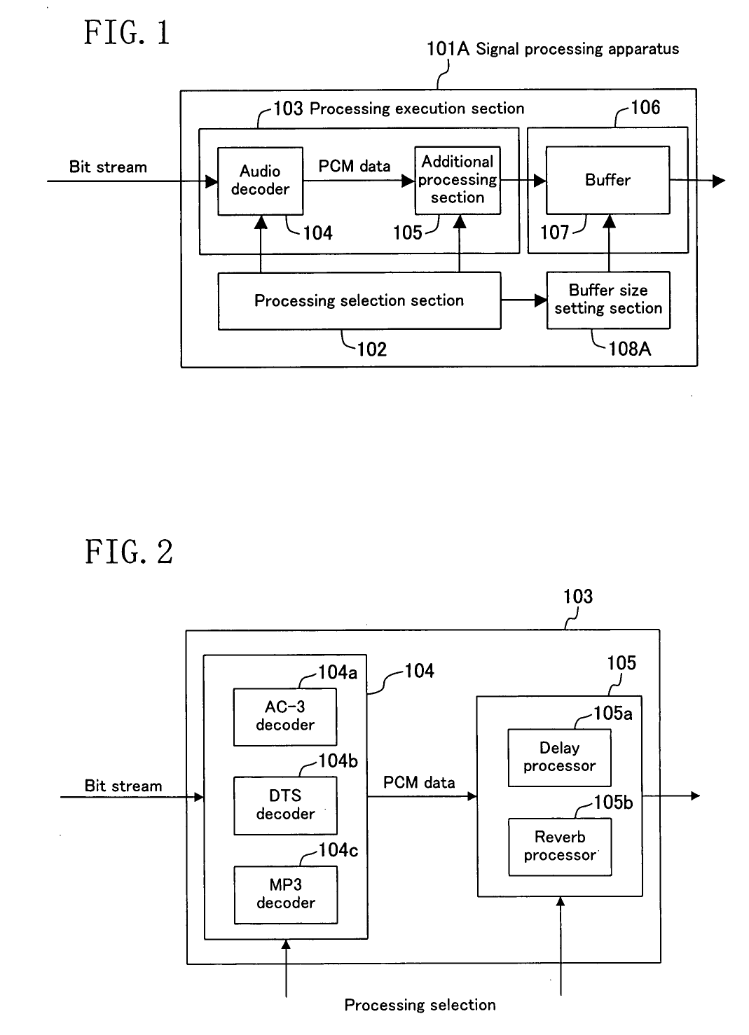

FIG. 1 is a diagram illustrating a configuration of a signal processing apparatus according to a first embodiment of the present invention. The signal processing apparatus 101A includes a processing selection section 102 for selecting processing to be performed to a received bit stream, a processing execution section 103 for executing processing selected by the processing selection section 102, a buffer 107 which buffers data processed by the processing execution section 103 and of which size is variable and a buffer size setting section 108A for setting a buffer size of the buffer 107.

The processing execution section 103 includes an audio decoder 104 for converting a bit stream to PCM data and an additional processing section 105 for performing additional processing to the PCM data. Moreover, the buffer 107 is ensured on a SDRAM (Synchronous Dynamic Random Access Memory) 106 and an empty region of the SDRAM 106 can be also used for something other than the signal processing apparatus 101A.

FIG. 2 is a diagram illustrating an exemplary configuration of the processing execution section 103 of FIG. 1. The audio decoder 104 includes an AC-3 (Audio Code number 3) decoder 104a, a DTS decoder 104b and an MP3 (MPEG Audio Layer-3) decoder 104c. The additional processing section 105 includes a delay processor 105a and a reverb processor 105b.

In the audio decoder 104, any one of the AC-3 decoder 104a, the DTS decoder 104b and the MP3-decoder 104c can be selected. In the additional processing section 105, the delay processor 105a and the reverb processor 105b can be selected and either one or both of the delay processor 105a and the reverb processor 105b can be enabled. A decoder to be enabled in the audio decoder 104 and additional processing to be enabled in the additional processing section 105 are selected by the processing selection section 102.

A buffer size setting section 108A sets, specifically, based on a type of processing corresponding to a selection result of the processing selection section 102, a buffer size of the buffer 107 is set with reference to a buffer size table prepared beforehand.

The following is how the buffer size is determined. First, a table index X is obtained from Equation 1.

X=2²·A+2¹·B+2⁰·C (Equation 1)

In this case, when the AC-3 decoder 104a is selected as the audio decoder 104, A=0 holds. When the DTS decoder 104b is selected as the audio decoder 104, A=1 holds. When the MP3-decoder 104c is selected as the audio decoder 104, A=2 holds. Moreover, when the delay processor 105a is enabled, B=1 holds. When the delay processor 105a is disabled, B=0 holds. When the reverb processor 105b is enabled, C=1 holds. And when the reverb processor 105b is disabled, C=0 holds.

Next, using the obtained table index X, with reference to a buffer size table, a buffer size is determined.

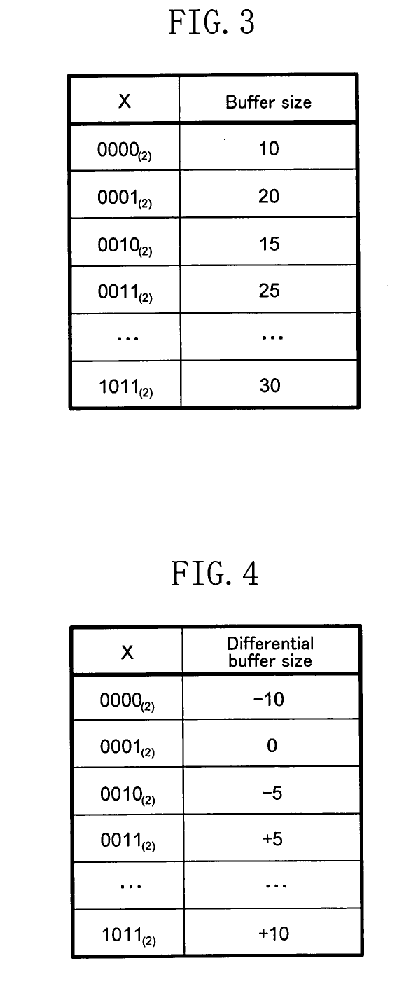

FIG. 3 is an exemplary buffer size table. The buffer size table is prepared beforehand by determining a minimum buffer size with which underflow does not occur based on calculations or actual measurements according to processing.

For example, when the AC-3 decoder 104a is enabled as the audio decoder 104 and the delay processor 105a is enabled as the additional processing section 105, A=0, B=1 and C=0 hold and X=0010₍₂₎ is obtained from Equation 1. With reference to a buffer size table shown in FIG. 3, the buffer size corresponding to X=0010₍₂₎ is “15” and the buffer size setting section 108A sets “15” as a buffer size of the buffer 107.

FIG. 4 is another exemplary buffer size table. The buffer size table of FIG. 4 shows differential buffer sizes when a specified value of the buffer size is set to be “20”.

For example, when the MP3-decoder 104c is enabled as the audio decoder 104 and the delay processor 105a and the reverb processor 105b are enabled as the additional processing section 105, A=2, B=1 and C=1 hold and X=1011₍₂₎ is obtained from Equation 1. With reference to the buffer size table of FIG. 4, a differential buffer size corresponding to X=1011₍₂₎ is “+10”. The buffer size setting section 108A set as a buffer size, a value “30” obtained by adding the referred value to the specified value, i.e., “20” in FIG. 3.

Thus, the buffer size setting section 108A may add a value corresponding to a type of processing selected by the processing selection section 102 to the specific value, calculate a buffer size and set the obtained value as the buffer size of the buffer 107.

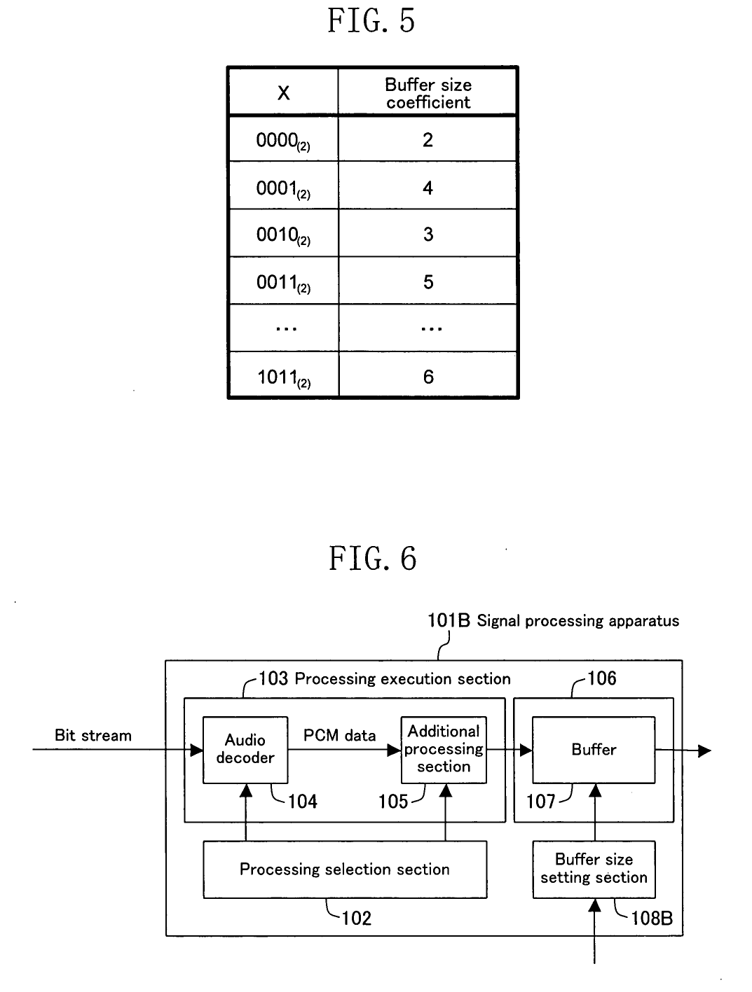

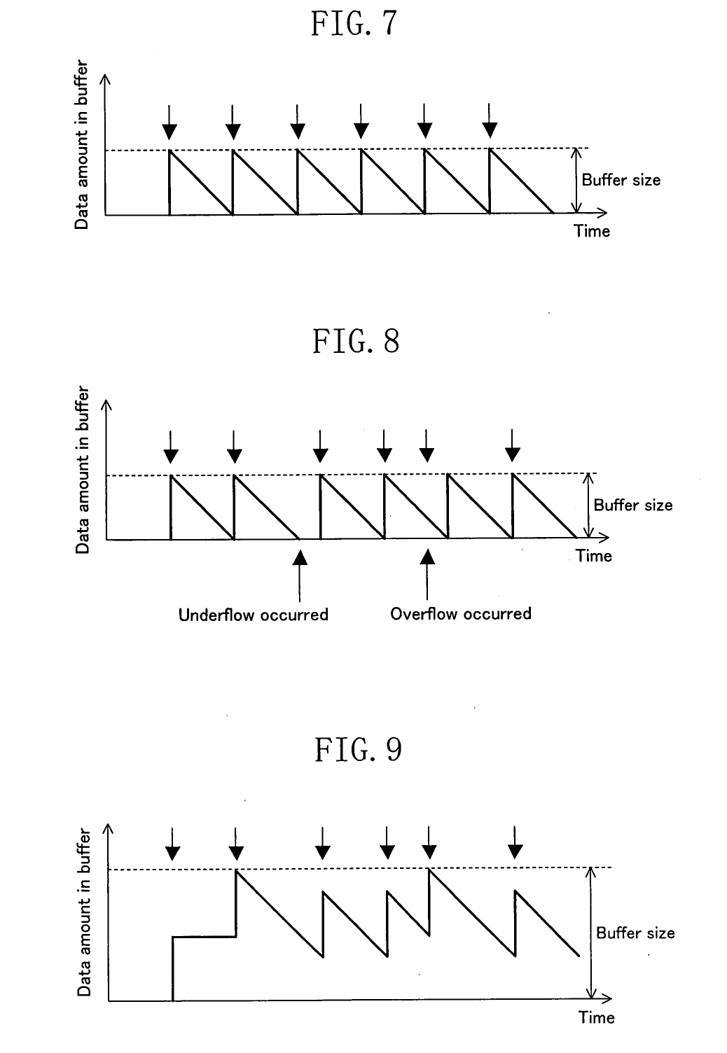

FIG. 5 is still another exemplary buffer size table. The buffer size table of FIG. 5 shows buffer size coefficients when a buffer size is a multiple of a certain number. For example, in FIG. 3, each buffer size is a multiple of “5”, buffer coefficients when the specific value is “5” can be shown as in FIG. 5.

For example, when the AC-3 decoder 104a is enabled as the audio decoder 104 and the reverb processor 105b is enabled as the additional processing section 105, A=0, B=0 and C=1 hold and X=0001₍₂₎ is obtained from Equation 1. Accordingly, with reference to the buffer size table of FIG. 5, the buffer size coefficient corresponding to X=0001 is “4”. The buffer size setting section 108A sets, as the buffer size of the buffer 107, “20” obtained by multiplying a specified value “5” by the referred coefficient.

As has been described, the buffer size setting section 108A may multiply a specified value by a coefficient corresponding to a type of processing selected by the processing selection section 102 to obtain the buffer size and set the obtained buffer size as the buffer size of the buffer 107.

Moreover, the buffer size setting section 108A may operate a variant indicating the selection result of the processing selection section 102 using a function which has been determined beforehand based on calculations or actual measurements and set the obtained variant as the buffer size of the buffer 107.

In this embodiment, the buffer 107 is ensured on the SDRAM 106, but may be ensured on some other storage medium such as a disk drive or the like.

As has been described, according to this embodiment, the buffer size is properly set by the buffer size setting section 108A according to processing selected by the processing selection section 102. Accordingly, the occurrence of underflow can be prevented particularly without reducing processing precision. Furthermore, the buffer size to be ensured on a storage medium such as a SDRAM and the like can be suppressed at a necessity minimum. Therefore, an empty region of the storage medium can be effectively utilized for some other processing.

### Second Embodiment

FIG. 6 is a diagram illustrating a configuration of a signal processing apparatus according to a second embodiment of the present invention. The signal processing apparatus 101B includes a buffer size setting section 108B, instead of the buffer size setting section 108A in the signal processing apparatus 101A of FIG. 1. Other than that, the configuration is the same as the configuration of FIG. 1. Therefore, each member also shown in FIG. 1 is identified by the same reference numeral and the description will not repeated here.

The buffer size setting section 108B sets a buffer size of the buffer 107 based on an external setting. For example, when the buffer size setting section 108B is externally instructed to set “10”, the buffer size setting section 108B sets “10” as a buffer size of the buffer 107.

According to this embodiment, a buffer size is set to be an arbitrary value by the buffer size setting section 108B. Accordingly, the buffer size to be ensured on a storage medium such as a SDRAM and the like can be adjusted to be a necessity minimum. Therefore, other regions can be effectively utilized.

### INDUSTRIAL APPLICABILITY

In a signal processing apparatus according to the present invention, a buffer size can be properly set according to a type of selected processing. Therefore, the signal processing apparatus according to the present invention is effective in a signal processing apparatus for outputting processed data in real time, and specifically, in an audio reproduction apparatus.

1-10. (canceled)

11. A signal processing apparatus comprising:
a processing selection section for selecting, from a plurality of audio signal processings, processing to be executed to an input audio bit stream;
a processing execution section for converting the input audio bit stream into PCM data for signal processing selected by the processing selection section and executing the signal processing selected by the processing selection section to the PCM data;
a buffer for buffering the PCM data processed by the processing execution section, the buffer having a variable buffer size; and
a buffer size setting section for setting a buffer size of the buffer based on a selection result of the processing execution section.

12. The signal processing apparatus of claim 11, wherein the buffer size setting section sets the buffer size corresponding to a type of processing selected by the processing selection section with reference to a predetermined table.

13. The signal processing apparatus of claim 12, wherein the buffer size setting section adds a value corresponding to the type of the processing selected by the processing selection section to a specified value to calculate the buffer size.

14. The signal processing apparatus of claim 12, wherein the buffer size setting section multiplies a specified value by a value corresponding to the type selected by the processing selection section.

15. The signal processing apparatus of clam 11, wherein the buffer size setting section operates a variant indicating the selection result of the processing selection section using a predetermined function to calculate the buffer size.

16. A signal processing apparatus comprising:
a processing selection section for selecting, from a plurality of audio signal processings, processing to be executed to an input audio bit stream;
a processing execution section for converting the input audio bit stream into PCM data for signal processing selected by the processing selection section and executing the signal processing selected by the processing selection section to the PCM data;
a buffer for buffering the PCM data processed by the processing execution section, the buffer having a variable buffer size; and
a buffer size setting section for setting a buffer size of the buffer based on an external setting.

17. The signal processing section of claim 11, wherein the buffer is formed of a memory.

18. The signal processing section of claim 16, wherein the buffer is formed of a memory.

19. The signal processing section of claim 11, wherein the buffer is formed of a disk drive.

20. The signal processing section of claim 16, wherein the buffer is formed of a disk drive.

21. A signal processing method comprising the steps of:
a first step of selecting, from a plurality of audio signal processings, processing to be executed to input audio bit stream;
a second step of converting the input audio bit stream into PCM data for signal processing selected in the first step and executing the signal processing selected in the first step to the PCM data;
a third step of setting a buffer size of a buffer based on a selection result in the first step, the buffer having a variable buffer size; and
a step of buffering the PCM data processed in the second step to the buffer.

22. A signal processing method comprising the steps of:
a first step of selecting, from a plurality of audio signal processings, processing to be executed to input audio bit stream;
a second step of converting the input audio bit stream into PCM data for signal processing selected in the first step and executing the signal processing selected in the first step to the PCM data;
a third step of setting a buffer size of a buffer based on an external setting, the buffer having a variable buffer size; and
a step of buffering the PCM data processed in the second step to the buffer.
